(19) United States
(12) Patent Application Publication
(10) Pub. No.: US 2007/0123177 A1
(43) Pub. Date: May 31, 2007

(54) Home appliance with radio reception function

(75) Inventors: Seong Hae Jeong, Changwon-si (KR); Byung Hwan Ahn, Gimhae-si (KR); Hyeok Deok Kim, Changwon-si (KR); Hung Myong Cho, Gimhae-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/477,795

(22) Filed: Jun. 30, 2006

(30) Foreign Application Priority Data
Jun. 30, 2005 (KR) 10-2005-57659
Jun. 30, 2005 (KR) 10-2005-57664

(51) Int. Cl. H04B 1/38

(52) U.S. Cl. 455/90.1

(57) ABSTRACT

A home appliance with a radio reception function is disclosed. The home appliance includes a washing device for washing or drying clothes, and a radio module for providing the radio reception function and outputting a current washing or drying progress state of the washing device in audio form through data communication with the washing device.

This application claims the benefit of Korean Patent Application Nos. 10-2005-0057659 and 10-2005-0057664, filed on Jun. 30, 2005, which are hereby incorporated by reference as if fully set forth herein.

### BACKGROUND OF THE INVENTION

1. Field of the Invention

The present invention relates to a home appliance, and more particularly, to a home appliance having a radio reception function.

2. Discussion of the Related Art

Generally, a washing machine is an electric home appliance, which is most widely used in homes to remove contaminants attached to laundry such as clothes by utilizing a softening action of detergent, a frictional action of wash water flows resulting from a rotational action, an impact of the wash water flows applied to the laundry, etc.

For such washing machines, products of various washing types, for example, a pulsator type, agitator type, drum type, etc. are commercially available. Such washing machines may also be classified into a separation type and a full automation type in terms of whether or not washing and spin-drying tubs are separated from each other.

For most washing machines, the user uses the washing machines by properly setting washing conditions, such as a washing time, rinsing time and spin-drying time, according to the materials or amount of laundry.

A plurality of washing course programs are pre-stored in a memory so that they may be selectively utilized by the user to perform automatic washing for the user's convenience.

For example, a variety of washing course programs, such as centrifugal washing, high-concentration washing, prewashing, vibration washing, annealing washing and wool washing, may be pre-stored in the memory so that the user can simply and conveniently select a desired washing course to execute the automatic washing.

Besides, a drying machine is a home appliance which has a similar structure and is used in a similar manner.

Meanwhile, nowadays, customer concerns and desires for upgradation of home appliances are increasing. For this reason, in spite of the repeated development of home appliances for the user's convenience as mentioned above, it is next to impossible to expect that the customers will be satisfied with only the existing home appliances.

Recently, in a home appliance field, a multifunctionalization to integrate composite functions in one product is being attempted, as well as a high functionalization to improve the original function of the product.

These attempts are contrary evidence that the home appliance market has been saturated, but results of efforts to provide more excellent and convenient products through continuous technical development.

However, for a washing apparatus, such as a washing machine or drying machine, the user requires a higher technique than is currently possible, resulting in an increase in product cost of the washing apparatus and, in turn, a limitation in universal use thereof. In this regard, at present, there is a need for a new technique capable of readily acquiring various information even at low cost.

### SUMMARY OF THE INVENTION

Accordingly, the present invention is directed to a home appliance with a radio reception function that substantially obviates one or more problems due to limitations and disadvantages of the related art.

An object of the present invention is to provide a home appliance with a radio reception function which can be universally used at a lower cost.

Another object of the present invention is to provide a home appliance with a radio reception function which can significantly increase customer satisfaction with a multifunctionalization thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a home appliance with a radio reception function comprises: a washing device for washing or drying clothes; and a radio module for providing the radio reception function and outputting a current washing or drying progress state of the washing device in audio form through data communication with the washing device.

The home appliance may further comprise a monitor device for remotely controlling and monitoring an operation of the washing device through communication with the washing device.

The radio module may be included in the monitor device.

In another aspect of the present invention, a home appliance with a radio reception function comprises: a washing device for washing or drying clothes; and a radio module installed in the washing device, the radio module providing the radio reception function and outputting a current washing or drying progress state of the washing device in audio form through communication with the washing device.

The home appliance may further comprise a remote controller for inputting control commands from a user to the washing device and radio module.

Preferably, the remote controller comprises a key panel for control of the washing device, and a key panel for control of the radio module, whereby the remote controller is used in common for the washing device and radio module.

Each of the washing device and radio module may comprise an infrared receiver for receiving a key code transmitted from a remote controller.

The washing device and the radio module may be interconnected via a serial communication line so that they can perform data communication therebetween.

Preferably, the washing device comprises: a key input unit for inputting washing or drying mode conditions from a user; a load driver for driving loads necessary for a washing or drying mode; a display unit for displaying current mode conditions in progress and the current washing or drying progress state; and a controller for controlling the mode according to the mode conditions inputted from the user and outputting the current washing or drying progress state to the radio module.

The washing device may further comprise an Internet-connectable communication unit.

Preferably, the radio module comprises: a key input unit for inputting a power, volume and frequency of the radio module from a user; a display unit for displaying the volume and frequency inputted through the key input unit; a radio frequency (RF) receiver for receiving an RF signal corresponding to the frequency inputted through the key input unit; a radio controller for processing the RF signal received by the RF receiver or the current washing or drying progress state inputted from the washing device to convert it into an audio signal that can be outputted; and an audio output unit for outputting the audio signal from the radio controller.

The key input unit, display unit and audio output unit may be disposed on an outer surface of the washing device, and the RF receiver and radio controller may be disposed inside the washing device.

In yet another aspect of the present invention, a home appliance with a radio reception function comprises: a washing device for washing or drying clothes; and a monitor device for remotely controlling and monitoring an operation of the washing device through power line communication with the washing device, the monitor device having the radio reception function to receive a desired RF signal in response to a request from a user.

Preferably, the monitor device comprises: a communication unit for transmitting a control command to the washing device or receiving state information of the washing device therefrom through the power line communication with the washing device; an RF receiver for receiving the RF signal; an audio output unit for outputting the state information of the washing device received through the communication unit and the RF signal received by the RF receiver in the form of audio signals; and a monitor controller for performing the power line communication with the washing device or the radio reception function in response to a control command from the user to output the state information of the washing device or the RF signal through the audio output unit.

The communication unit may be a communication module which performs the power line communication.

The home appliance may further comprise a display unit for displaying the state information of the washing device received through the communication unit and a current radio volume/frequency.

The display unit may comprise a liquid crystal display.

The home appliance may further comprise a key input unit including a key panel for control of the washing device, and a key panel for control of the radio reception function.

The home appliance may further comprise a remote controller including a key panel for control of the washing device, and a key panel for control of the radio reception function.

The aforementioned home appliance with the radio reception function according to the present invention has effects as follows.

Firstly, the radio reception function is provided in the home appliance, thereby significantly increasing customer satisfaction with a multifunctionalization of the home appliance.

Secondly, it is possible not only to listen to the radio through the radio module of the home appliance, but also to output the mode progress state of the home appliance through the audio output unit of the radio module. Therefore, a product can be used more universally.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view showing a first embodiment of a home appliance with a radio reception function according to the present invention;

FIG. 2 is a perspective view of a radio module in FIG. 1;

FIG. 3 is a block diagram showing the configurations of the radio module and a washing machine body according to the first embodiment;

FIG. 4 is a perspective view showing a second embodiment of the home appliance with the radio reception function according to the present invention; and

FIG. 5 is a block diagram of a monitor device having the radio reception function in FIG. 4.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

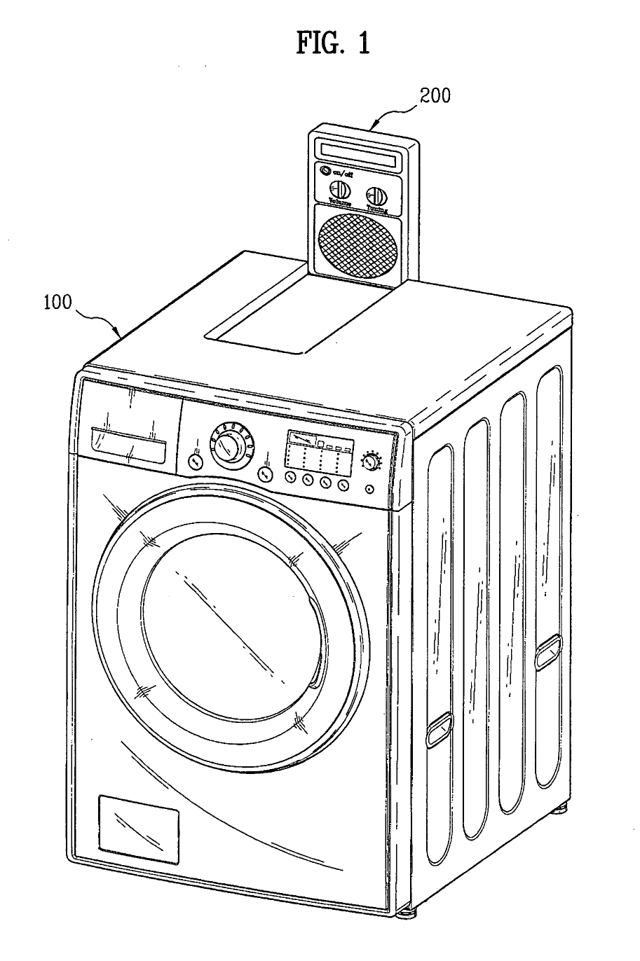

A first embodiment of a home appliance with a radio reception function according to the present invention will hereinafter be described with reference to FIG. 1 to FIG. 3.

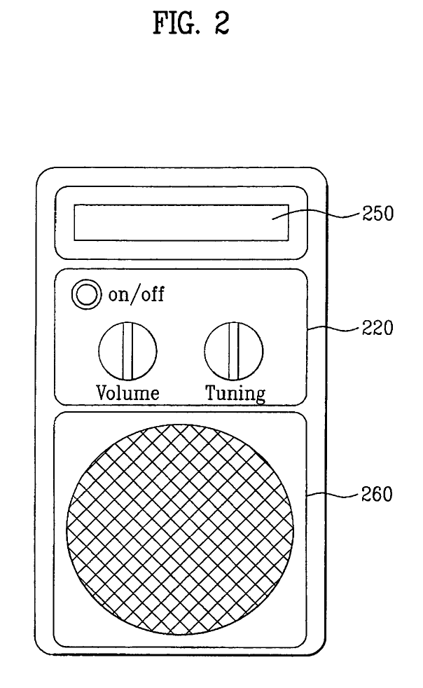

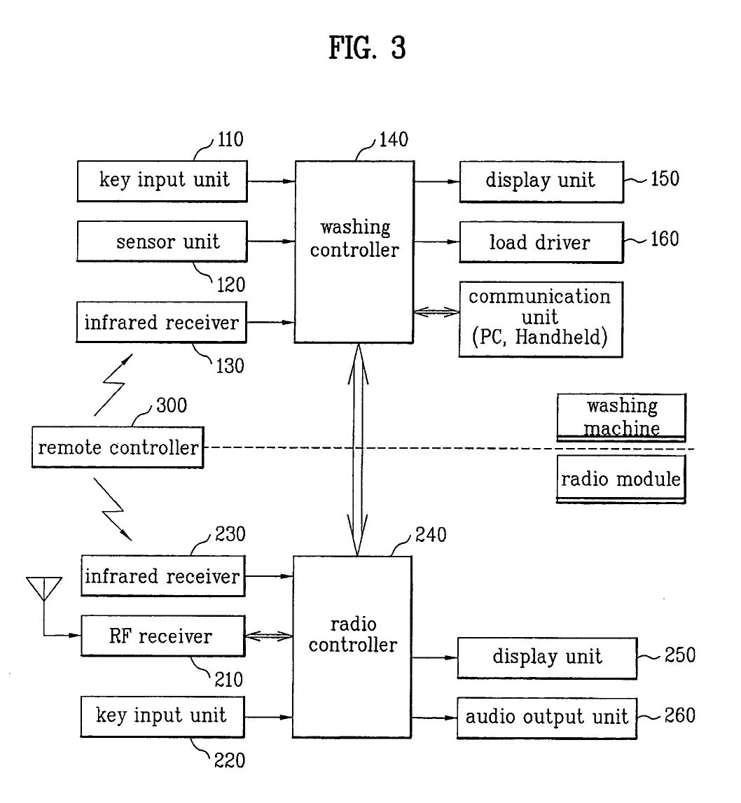

FIG. 1 is a perspective view showing the first embodiment of the home appliance, for example, a washing machine, with the radio reception function according to the present invention, FIG. 2 is a perspective view of a radio module in FIG. 1, and FIG. 3 is a block diagram showing the configurations of the radio module and a washing machine body according to the first embodiment.

The washing machine with the radio reception function according to the first embodiment comprises a washing machine body 100 having a drum into which laundry is put and adapted for washing the laundry in the drum by a rotational action of the drum, and a radio module 200 installed at a predetermined position of the washing machine body 100 integrally with the body 100 and adapted for providing the radio reception function and outputting a current washing progress state of the washing machine body 100 in audio form through communication with the washing machine body 100.

The washing machine body 100 is adapted to perform a washing mode for laundry put therein by the user. To this end, the washing machine body 100 includes a key input unit 110 for inputting various washing mode conditions from the user, a sensor unit 120 for sensing various mode states, such as the amount of laundry, the level of wash water, the temperature of wash water and the rotation speed of a motor, required in the washing mode, a display unit 150 for displaying current mode conditions in progress and a current washing progress state, a load driver 160 for driving loads (a feed/drain valve, motor, etc.) necessary for the washing mode, and a washing controller 140 for controlling the entire operation of the washing mode according to the washing mode conditions inputted through the key input unit 110 and the mode states sensed by the sensor unit 120.

The washing machine body 100 further includes a personal communication unit (a personal computer (PC), handheld device or the like) capable of performing Internet communication. The communication unit enables the user to use, over the Internet, a variety of services including downloading washing course programs.

The radio module 200 is adapted to receive a radio frequency (RF) signal. To this end, the radio module 200 includes a key input unit 220 for inputting a power, volume and frequency of the radio module from the user, a display unit 250 for displaying the volume and frequency inputted through the key input unit 220, an RF receiver 210 for receiving an RF signal corresponding to the frequency inputted through the key input unit 220, a radio controller 240 for processing the RF signal received by the RF receiver 210 to convert it into an audio signal that can be outputted, and an audio output unit 260 for outputting the audio signal from the radio controller 240.

In the present first embodiment, the radio module 200 is installed in the side or top plate of a cabinet constituting the outer appearance of the washing machine body 100 in a folded manner.

In detail, the RF receiver 210 and the radio controller 240, among the constituent elements of the radio module 200, are disposed inside the washing machine body 100 for efficient spatial utilization thereof, and the display unit 250 and the audio output unit 260 are disposed outside the washing machine body 100 under the condition of being physically separated from the radio controller 240.

That is, the arrangement of the radio module 200 provided on the outer surface of the washing machine body 100 corresponds to the key input unit 220, display unit 250 and audio output unit 260, as shown in FIG. 2.

The washing controller 140, provided inside the washing machine body 100, and the radio controller 240 are interconnected via a serial communication line such that data communication is enabled between the washing machine body 100 and the radio module 200.

With this configuration, while the washing mode is performed by the washing machine body 100, the current washing progress state can be outputted by the audio output unit 260 of the radio module 200 through the data communication between the washing machine body 100 and the radio module 200.

The washing machine according to this first embodiment further comprises a remote controller 300 for inputting control commands to the washing machine body 100 and radio module 200. A key panel for control of the washing machine body 100 and a key panel for control of the radio module 200 are together provided in the remote controller 300 so that the remote controller 300 can be used for both the washing machine body 100 and radio module 200.

That is, a key panel corresponding to the key input unit 110 of the washing machine body 100 and a key panel corresponding to the key input unit 220 of the radio module 200 are together provided in the remote controller 300.

A code format of the washing machine body 100 and a code format of the radio module 200 are together provided in the remote controller 300 so that the remote controller 300 can transmit a key code based on the corresponding code format of a key panel operated by the user.

The washing machine body 100 and the radio module 200 further include infrared receivers 130 and 230, respectively. Each of the infrared receivers 130 and 230 acts to receive a key code transmitted from the remote controller 300.

With this configuration, the infrared receivers 130 and 230 receive key codes transmitted from the remote controller 300 and transfer the received key codes to the washing controller 140 and radio controller 240, respectively. At this time, the washing controller 140 and radio controller 240 recognize only key codes of the code formats corresponding thereto.

A description will hereinafter be given of the operation of the first embodiment of the washing machine with the radio reception function according to the present invention, constructed as stated above.

First, in the washing machine body 100, the washing controller 140 controls the load driver 160 to drive loads necessary for the washing mode in consideration of washing mode conditions inputted by the user or mode states sensed by the sensor unit 120.

At this time, the washing controller 140 displays current mode conditions in progress or a current washing progress state through the display unit 150 of the washing machine body 100.

Further, the washing controller 140 transfers information regarding the current washing progress state to the radio controller 240 through communication with the radio controller 240.

Meanwhile, in the radio module 200, if the user turns on the power of the radio module 200 through the key input unit 220 and then inputs a desired radio frequency and a desired radio volume through the key input unit 220, the display unit 250 displays the radio volume and frequency inputted through the key input unit 220.

Then, the RF receiver 210 receives a radio broadcast signal corresponding to the radio frequency inputted by the user and transfers it to the radio controller 240.

The radio controller 240 receives the radio broadcast signal from the RF receiver 210, processes it to convert it into an audio signal that can be outputted, and then outputs the converted audio signal to the audio output unit 260.

As a result, the audio signal of the frequency selected by the user is outputted through the audio output unit 260, so that the user can listen to a desired radio broadcast.

On the other hand, the radio controller 240 receives information regarding a current washing progress state of the washing machine body 100 through communication with the washing controller 140 and processes the received washing progress state information to convert it into an audio signal that can be outputted through the audio output unit 260.

For example, when a mode error, such as washing eccentricity, occurs in the washing machine body 100 or the washing mode is ended, the resulting signal is transmitted from the washing controller 140 to the radio controller 240 and then outputted through the audio output unit 260 of the radio module in the form of a voice notification message or buzzer sound under the control of the radio controller 240.

Therefore, according to the present first embodiment, the radio module is installed in the washing machine integrally therewith so that the user can listen to the radio through the washing machine. Also, the washing progress state of the washing machine can be outputted through the audio output unit of the radio module.

On the other hand, recently, with the increase in the living space of a house, a washing machine or drying machine (referred to hereinafter only as a “washing machine”) is on a trend of being installed and used in a separate place distant from the living space, such as the outdoors or the basement of the house.

In the case where a washing machine is installed away from the living space like this, the user has to frequently visit a place where the washing machine is installed, to control the washing machine or monitor the operation state thereof, resulting in an inconvenience to the user.

In order to overcome this problem, recently, research has been done for a remote control technique capable of controlling a washing machine installed away from the living space of the user or monitoring the operation state thereof.

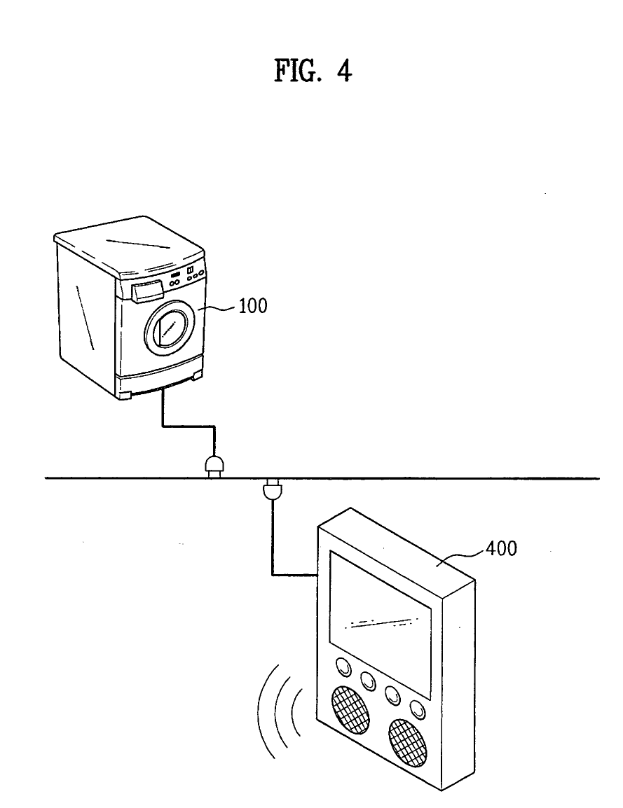

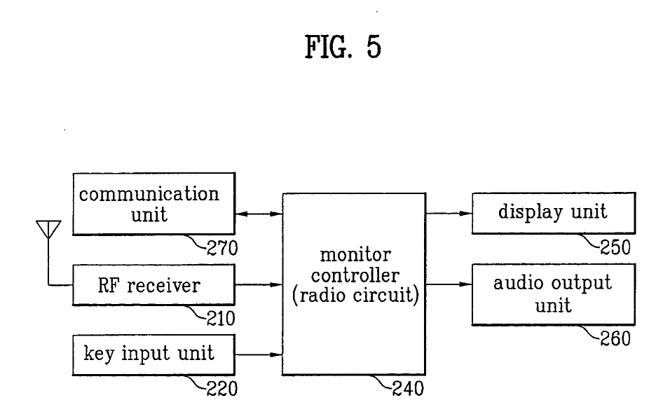

A second embodiment of the home appliance with the radio reception function according to the present invention will hereinafter be described with reference to FIG. 4 and FIG. 5.

FIG. 4 is a perspective view showing the second embodiment of the home appliance, for example, a washing machine, with the radio reception function according to the present invention, and FIG. 5 is a block diagram of a monitor device having the radio reception function in FIG. 4.

In the second embodiment, the washing machine body 100 is installed in a separate space, such as the outdoors or the basement of a house, to periodically transmit information regarding a current washing progress state through power line communication.

In contrast, the monitor device, denoted by reference numeral 400, is installed in the living space of the house such that it can be more readily used by the user.

Thus, the monitor device 400 can not only remotely control the distant washing machine body 100 from within the house through the power line communication with the washing machine body 100, but also check the state information transmitted from the washing machine body 100 and output the washing progress state including washing mode conditions, the remaining mode time, mode errors, mode start/end, etc. in various forms (image or audio).

The present second embodiment is characterized in that the radio reception function is additionally provided in the monitor device 400 which is means for the remote control of the washing machine body 100.

To this end, the monitor device 400 includes a key input unit 220 for inputting a washing machine control command and a control command for the radio reception function from the user, a communication unit 270 for transmitting the washing machine control command to the washing machine body 100 or receiving state information of the washing machine body 100 therefrom through the power line communication with the washing machine body 100, an RF receiver 210 for receiving an RF signal, a display unit 250 for displaying the state information of the washing machine body 100 and a radio volume/frequency, an audio output unit 260 for outputting the state information of the washing machine body 100 and the RF signal in the form of audio signals, and a monitor controller 240 for performing the power line communication with the washing machine body 100 or the radio reception function in response to a control command from the user.

The communication unit 270 is a communication module capable of performing the power line communication, for example, a power line modem. This communication unit 270 can perform data communication with the washing machine body 100 without using a network such as a gateway or a communication network such as the Internet.

The monitor controller 240 is equipped with an application program to perform the radio reception function through a radio circuit (not shown) included therein, as well as the data communication with the washing machine body 100.

The monitor device 400 includes the audio output unit 260 to output the RF signal, as well as the state information of the washing machine body, in the form of audio signals. The audio output unit 260 is installed in the side or front plate of a cabinet constituting the outer appearance of the monitor device 400.

The display unit 250 includes a liquid crystal display (LCD) to display the state information of the washing machine body 100 and the radio volume/frequency.

The key input unit 220 is adapted to receive a control command signal based on a key operation of the user and transfer it to the monitor controller 240. A key panel for washing-associated control and a key panel for control of the radio reception function are together provided in the key input unit 220.

In order to remotely control the monitor device 400, a remote controller (not shown) may be provided which has the same key panels as those of the key input unit 220.

A description will hereinafter be given of the operation of the second embodiment of the washing machine with the radio reception function according to the present invention, constructed as stated above.

First, the user turns on the power of the monitor device 400 through the key input unit 220 and then inputs a desired radio frequency and a desired radio volume through the key input unit 220.

At this time, the display unit 250 displays the radio volume and frequency inputted through the key input unit 220.

Then, the RF receiver 210 receives a radio broadcast signal corresponding to the radio frequency inputted by the user and transfers it to the monitor controller 240.

The monitor controller 240 receives the radio broadcast signal from the RF receiver 210, processes it to convert it into an audio signal that can be outputted, and then outputs the converted audio signal to the audio output unit 260.

As a result, the audio signal of the frequency selected by the user is outputted through the audio output unit 260 of the monitor device 400, so that the user can listen to a desired radio broadcast.

On the other hand, the monitor controller 240 receives the state information of the washing machine body 100 therefrom by performing the power line communication with the washing machine body 100 through the communication unit 270. The monitor controller 240 then not only displays the received state information, but also outputs it in the form of an audio signal as needed.

For example, when a mode error, such as eccentricity, occurs in the washing machine body 100 or the washing mode is ended, the resulting signal is transmitted to the monitor controller 240 and then outputted through the audio output unit 260 in the form of a voice error message or buzzer sound under the control of the monitor controller 240.

Meanwhile, upon receiving emergency state information, such as a mode error, from the washing machine body 100 in the middle of performing the radio reception function, the monitor controller 240 may suspend the RF signal output and preferentially output an audio signal corresponding to the received state information.

Therefore, according to the present second embodiment, the radio reception function is additionally provided in the monitor device which remotely controls the home appliance. Therefore, the user can listen to the radio through the monitor device.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A home appliance with a radio reception function comprising:
a washing device for washing or drying clothes; and
a radio module for providing the radio reception function and outputting a current washing or drying progress state of the washing device in audio form through data communication with the washing device.

2. The home appliance according to claim 1, further comprising a monitor device for remotely controlling and monitoring an operation of the washing device through communication with the washing device.

3. The home appliance according to claim 2, wherein the radio module is included in the monitor device.

4. A home appliance with a radio reception function comprising:
a washing device for washing or drying clothes; and
a radio module installed in the washing device, the radio module providing the radio reception function and outputting a current washing or drying progress state of the washing device in audio form through communication with the washing device.

5. The home appliance according to claim 4, further comprising a remote controller for inputting control commands from a user to the washing device and radio module.

6. The home appliance according to claim 5, wherein the remote controller comprises a key panel for control of the washing device, and a key panel for control of the radio module, whereby the remote controller is used in common for the washing device and radio module.

7. The home appliance according to claim 4, wherein each of the washing device and radio module comprises an infrared receiver for receiving a key code transmitted from a remote controller.

8. The home appliance according to claim 4, wherein the washing device and the radio module are interconnected via a serial communication line so that they can perform data communication therebetween.

9. The home appliance according to claim 4, wherein the washing device comprises:
a key input unit for inputting washing or drying mode conditions from a user;
a load driver for driving loads necessary for a washing or drying mode;
a display unit for displaying current mode conditions in progress and the current washing or drying progress state; and
a controller for controlling the mode according to the mode conditions inputted from the user and outputting the current washing or drying progress state to the radio module.

10. The home appliance according to claim 9, wherein the washing device further comprises an Internet-connectable communication unit.

11. The home appliance according to claim 4, wherein the radio module comprises:
a key input unit for inputting a power, volume and frequency of the radio module from a user;
a display unit for displaying the volume and frequency inputted through the key input unit;
a radio frequency (RF) receiver for receiving an RF signal corresponding to the frequency inputted through the key input unit;
a radio controller for processing the RF signal received by the RF receiver or the current washing or drying progress state inputted from the washing device to convert it into an audio signal that can be outputted; and
an audio output unit for outputting the audio signal from the radio controller.

12. The home appliance according to claim 11, wherein the key input unit, display unit and audio output unit are disposed on an outer surface of the washing device, and the RF receiver and radio controller are disposed inside the washing device.

13. A home appliance with a radio reception function comprising:
a washing device for washing or drying clothes; and
a monitor device for remotely controlling and monitoring an operation of the washing device through power line communication with the washing device, the monitor device having the radio reception function to receive a desired RF signal in response to a request from a user.

14. The home appliance according to claim 13, wherein the monitor device comprises:
a communication unit for transmitting a control command to the washing device or receiving state information of the washing device therefrom through the power line communication with the washing device;
an RF receiver for receiving the RF signal;
an audio output unit for outputting the state information of the washing device received through the communication unit and the RF signal received by the RF receiver in the form of audio signals; and
a monitor controller for performing the power line communication with the washing device or the radio reception function in response to a control command from the user to output the state information of the washing device or the RF signal through the audio output unit.

15. The home appliance according to claim 14, wherein the communication unit is a communication module which performs the power line communication.

16. The home appliance according to claim 14, further comprising a display unit for displaying the state information of the washing device received through the communication unit and a current radio volume/frequency.

17. The home appliance according to claim 16, wherein the display unit comprises a liquid crystal display.

18. The home appliance according to claim 14, further comprising a key input unit including a key panel for control of the washing device, and a key panel for control of the radio reception function.

19. The home appliance according to claim 14, further comprising a remote controller including a key panel for control of the washing device, and a key panel for control of the radio reception function.
